(19) United States
(12) Patent Application Publication
(10) Pub. No.: US 2026/0296540 A1
(43) Pub. Date: Oct. 1, 2026

(54) STEERING LOAD DETECTION SYSTEMS AND RELATED METHODS

(71) Applicant: Ford Global Technologies, LLC, Dearborn, MI (US)

(72) Inventor: Gabriel James Lawless, Pinckney, MI (US)

(21) Appl. No.: 19/091,342

(22) Filed: Mar. 26, 2025

(51) Int. Cl. B62D 15/02; B62D 5/04; G01B 21/22; G07C 5/00

(52) U.S. Cl. CPC B62D 15/0215; B62D 5/0424; B62D 5/0442; G01B 21/22; G07C 5/006

(57) ABSTRACT

Systems, apparatus, articles of manufacture, and methods are disclosed Steering load detection systems and related methods are disclosed. An example apparatus includes memory; machine-readable instructions; and at least one programmable circuit to at least one of instantiate or execute the machine-readable instructions to determine an acceleration of a rack of a steering system of a vehicle based on one or more of position data for a shaft of a pinion of the steering system or position data for a shaft of a motor of the steering system; determine a force applied to a tie rod of the vehicle based on the acceleration of the rack; and cause a message to be output based on the force.

### FIELD OF THE DISCLOSURE

This disclosure relates generally to steering systems and, more particularly, to steering load detection systems and related methods.

### BACKGROUND

A vehicle typically includes a mechanical linkage that couples the front wheels of the vehicle to a steering wheel. For instance, in a rack and pinion steering system, rotational movement of the steering wheel is translated to linear movement of the rack via a pinion coupled to a shaft of the steering wheel. Tie rods are coupled to respective ends of the rack. The tie rods transmit linear force from the rack to corresponding steering arms associated with the wheels to cause the wheels to turn.

### BRIEF DESCRIPTION OF THE DRAWINGS

FIG. 1 illustrates an example vehicle in which teachings of this disclosure can be implemented.

FIG. 2 illustrates an example steering system of the vehicle of FIG. 1.

FIG. 3 is a block diagram of the example steering system of FIG. 2 and an example electronic control unit of the vehicle of FIG. 1 including steering load monitoring circuitry.

FIG. 4 is a block diagram of an example implementation of the steering load monitoring circuitry of FIG. 3.

FIGS. 5 and 6 are flowcharts representative of example machine-readable instructions and/or example operations that may be executed, instantiated, and/or performed by example programmable circuitry to implement the steering load monitoring circuitry of FIG. 4.

FIG. 7 is a block diagram of an example processing platform including programmable circuitry structured to execute, instantiate, and/or perform the example machine-readable instructions and/or perform the example operations of FIGS. 5 and 6 to implement the steering load monitoring circuitry of FIG. 4.

In general, the same reference numbers will be used throughout the drawing(s) and accompanying written description to refer to the same or like parts. The figures are not necessarily to scale.

### DETAILED DESCRIPTION

As noted above, a vehicle typically includes a mechanical linkage that couples the front wheels of the vehicle to a steering wheel. In a rack and pinion steering system, rotational movement of the steering wheel is translated to linear movement of the rack via a pinion coupled to a shaft of the steering wheel. Tie rods are coupled to respective ends of the rack. The tie rods transmit linear force from the rack to corresponding steering arms associated with the wheels to cause the wheels to turn.

Tie rods associated with a front wheel of the vehicle include an inner tie rod coupled to the rack of the rack-and-pinion steering system and an outer tie rod coupled to the inner tie rod and a steering knuckle for the wheel. Excessive force on the steering system due to, for example, driving on a pothole or curb, can affect the structure of the tie rod(s) and, in particular, can cause the inner tie rod to deform. In some examples, such loads can additionally or alternatively affect the structural integrity of one or more components of a suspension system of the vehicle, such as steering knuckle(s) or control arm(s) that couple the vehicle chassis to the wheel hub. Such changes to the structural integrity of the inner tie rod(s) or other component(s) of the steering system and/or suspension system can cause the steering system to become misaligned.

Disclosed herein are example systems, apparatus, and methods of evaluating a structural condition of a component (e.g., an inner tie rod) of a steering system of a vehicle as a result of excessive force event(s) experienced by the component during operation of the vehicle. Examples disclosed herein can be implemented in a vehicle having a steering system including a movable rack. Examples disclosed herein determine an acceleration of the rack based on position data associated with a pinion shaft or motor shaft (e.g., in electric power steering systems). Using the acceleration of the rack, example steering load monitoring circuitry disclosed herein determines a force applied to the component (e.g., the inner tie rod). Examples disclosed herein correlate changes in acceleration of the rack with a load applied to the rack, which is used to determine load applied to the component such as the inner tie rod. Based on the force, the steering load monitoring circuitry determines (e.g., predicts) whether the inner tie rod has experienced an excessive force event that likely caused the inner tie rod to have relatively less structural integrity (e.g., due to buckling, bending, or other permanent and/or inelastic deformation of the inner tie rod) than prior to the excessive force event. For example, the steering load monitoring circuitry can compare the force applied to the inner tie rod to a force threshold for the inner tie rod.

In examples in which the steering load monitoring circuitry predicts that the structural integrity of the component of the steering system has changed due to an excessive force event, the steering load monitoring circuitry can verify the prediction based on an analysis of steering wheel alignment. For example, data from an antilock braking system (ABS) generated after a predicted excessive force event may indicate that the vehicle is driving straight or substantially straight. However, angular position data associated with the pinion shaft or the motor shaft can indicate that the steering wheel has shifted by more than a threshold amount after the predicted excessive force event. In such examples, the steering load monitoring circuitry confirms a likelihood that the component (e.g., the inner tie rod, a control arm, a steering knuckle) has less structural integrity than prior to the excessive force event based on detection of the misaligned steering wheel. As a result, the steering load monitoring circuitry causes message(s) to be output to the driver to, for example, inform a user that the component (e.g., the inner tie rod) or, more generally, that the structural integrity of the steering system may be affected; to inform the driver of a misaligned steering wheel; and/or to prompt the driver to visit a vehicle repair facility. The message(s) can include, for example, visual message(s) displayed on the vehicle dashboard, notification(s) transmitted to an application installed on a user device such as a smartphone, etc.

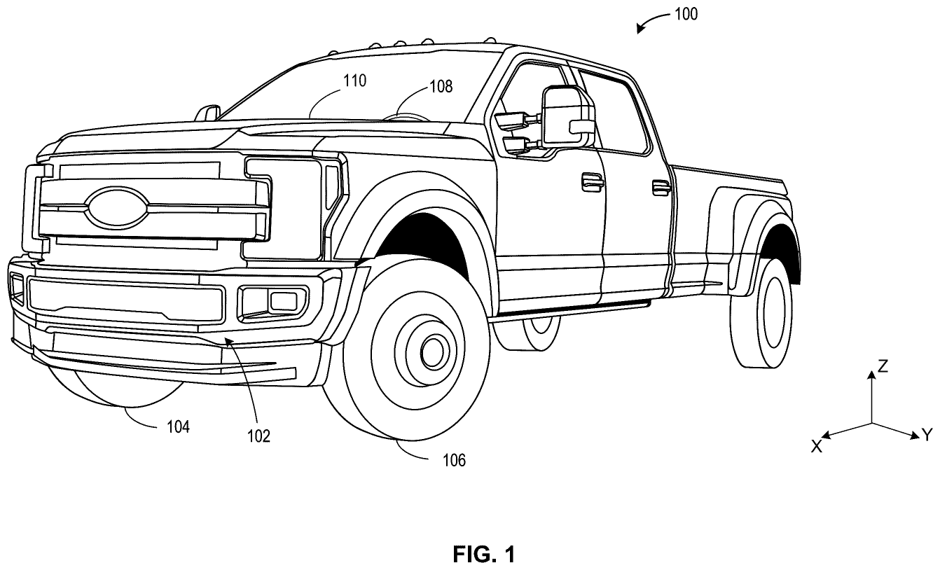

FIG. 1 illustrates an example vehicle 100 in which teachings of this disclosure can be implemented. The example vehicle 100 includes a steering system 102, a first wheel 104, and a second wheel 106. The steering system 102 of the example vehicle 100 includes a steering wheel 108 to transmit driver inputs to the steering system 102 (e.g. by rotating the steering wheel 108). The example vehicle 100 includes an instrument panel or dashboard 110 including a speedometer (and other gauges) as well as user interface(s) to present, for example, message(s) to a driver. The example vehicle 100 of FIG. 1 is a pick-up truck; however, the vehicle 100 can be any type of vehicle (e.g., a van, a sedan, a sports utility vehicle (SUV), a semi-trailer truck, an all-terrain vehicle (ATV), construction equipment, farming equipment, etc.). In the example of FIG. 1, the vehicle 100 is a two-axle vehicle. In other examples, the vehicle 100 can have additional axles and/or additional wheels.

The steering system 102 converts rotational motion of the steering wheel 108 into a lateral force via a steering gear (e.g., rack-and-pinion) to cause the wheels 104, 106 to change the direction of the vehicle 100. Although the example steering system 102 is used to control a front axle of the vehicle 100, examples disclosed herein can also apply to steering systems associated with rear-steered axles.

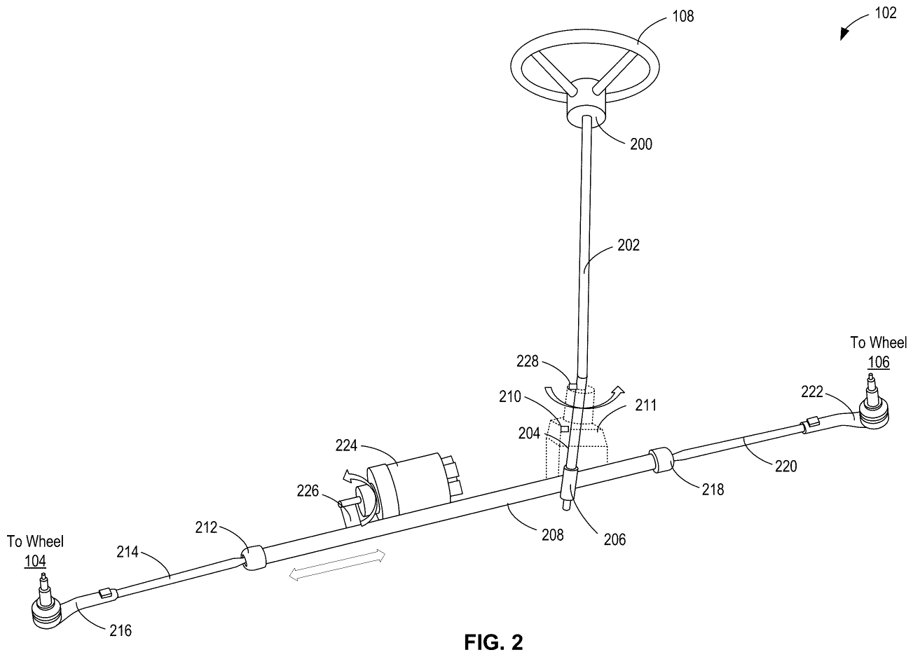

FIG. 2 illustrates an example steering system 102 of the vehicle 100 of FIG. 1. The example steering system 102 includes the steering wheel 108 coupled to a steering column 200. An intermediate shaft 202 extends between the steering column 200 and a pinion shaft 204. The pinion shaft 204 supports a pinion 206. The pinion 206 engages a rack 208 (e.g., via gear teeth of the pinion 206 and the rack 208). When a user rotates the steering wheel 108, the pinion 206 moves (e.g., rolls) along the rack 208 via the pinion shaft 204, which causes the rack 208 to move linearly (i.e., axial motion along a longitudinal axis of the rack 208). The example steering system 102 includes a pinion shaft position sensor 210 that outputs signals representing a rotational position (angular position) of the pinion shaft 204. The outputs of the pinion shaft position sensor 210 can be used to determine an angle of the steering wheel 108. In the example of FIG. 2, the pinion shaft position sensor 210 is in a housing 211 that includes at least a portion of the pinion shaft 204.

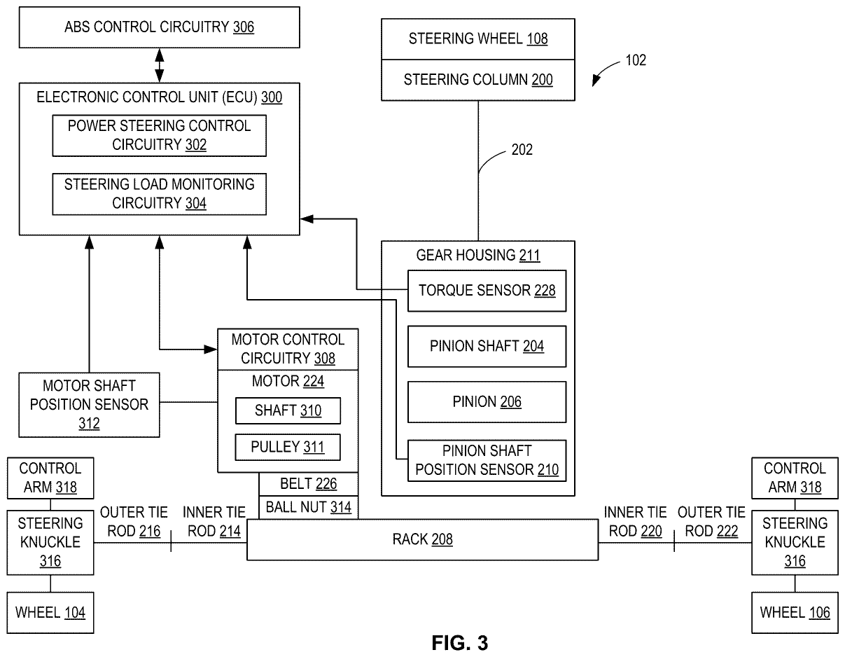

As shown in FIG. 2, a first end 212 of the rack 208 is coupled to a first inner tie rod 214. The first inner tie rod 214 is coupled to a first outer tie rod 216. Similarly, a second end 218 of the rack 208 is coupled to a second inner tie rod 220, which is coupled to a second outer tie rod 222. The outer tie rods 216, 222 are coupled to the corresponding wheels 104, 106 of FIG. 1 via, for example, steering knuckles 316 (FIG. 3). The steering knuckles 316 (FIG. 3) along with control arms 318 (FIG. 3) coupled respectively thereto are part of a suspension system of the vehicle 100.

The example steering system 102 of FIG. 2 provides for power assisted steering via a motor 224. In the example of FIG. 2, the motor 224 is coupled to the rack 208 via a belt 226 that is coupled to a portion of the rack 208. The motor 224 has a pulley (FIG. 3) and is coupled to a ball nut 314 (FIG. 3) to transfer torque generated by the motor 224 into a force that is applied to the rack 208 via the belt 226. The steering system 102 includes a torque sensor 228 output signals indicative of a torque applied to the steering wheel 108. As disclosed in connection with FIG. 3, motor control circuitry determines an assistive steering force to apply to the rack 208 via the motor 224 to facilitate movement of the rack 208 based on the outputs of the torque sensor 228. The belt 226 transfers rotational motion of the motor 224 to the rack 208 to cause the rack 208 to move via application of the assistive steering force (in addition to the force applied via the pinion 206). The belt 226 can drive, for example, ball bearings of the ball nut 314 that engage screw races of the rack 208 to transfer torque from the motor 224 to the rack 208. A motor shaft position sensor 312 (FIG. 3) outputs signals indicative of a rotational position of a shaft 310 (FIG. 3) of the motor 224.

FIG. 3 is a block diagram of the example steering system 102 of FIG. 2 and an example electronic control unit (ECU) 300 of the vehicle 100 of FIG. 1. In the example of FIG. 3, the ECU 300 includes power steering control circuitry 302 and steering load monitoring circuitry 304. Also, in the example of FIG. 3, the ECU 300 is in communication with antilock brake system (ABS) control circuitry 306 (e.g., programmable circuitry) of the vehicle 100. Although in the example of FIG. 3, the steering load monitoring circuitry 304 is shown as implemented by the ECU 300, in some examples, the steering load monitoring circuitry 304 is implemented by programmable circuitry separate from the ECU 300.

The example power steering control circuitry 302 of FIG. 3 receives outputs from the torque sensor 228 of the steering system 102. Based on the outputs of the torque sensor 228, which are indicative of torque applied to the steering wheel 108, the power steering control circuitry 302 determines the amount of steering assist force to apply to the rack 208 of the steering system 102. The power steering control circuitry 302 communicates with motor control circuitry 308 (e.g., programmable circuitry) to instruct the motor 224 to apply the assistive force to the rack 208 via the belt 226. As shown in FIG. 3, the motor 224 includes a shaft 310, a pulley 311 to drive the belt 226, and a ball nut 314, where the ball nut 314 is a rotating component coupled to the pulley 311 via the belt 226. The ball nut 314 rotates about the rack 208 to translate the rack 208 to change the angle of the wheels 104, 106. The ball nut 314 can include, for example, ball bearings that engage the screw races of the rack 208 to facilitate the transfer of rotational motion of the ball nut 314 to linear motion of the rack 208. Although in the example of FIG. 3, the vehicle 100 includes a belt-driven rack electric power assist steering system including the ball nut 314, examples disclosed herein can be used with other types of rack electric power assist steering systems.

The example steering load monitoring circuitry 304 of FIG. 3 determines (e.g., predicts) whether at least one component of the steering system 102 and/or the suspension system of the vehicle 100 has relatively less structural integrity due to, for example, the vehicle 100 of FIG. 1 driving over a pothole, a curb, etc., than prior to such an encounter with the pothole, curb, etc. Going forward, examples disclosed herein will be discussed primarily with respect to evaluating load(s) experienced by the inner tie rod(s) 214, 220. However, examples disclosed herein can be used to evaluate load(s) experienced by other component(s) of the steering system 102 (e.g., the outer tie rod(s) 216, 222) and/or the vehicle suspension system (e.g., steering knuckle(s) 316, control arm(s) 318) and to identify excessive force events that likely affected the structural integrity of those component(s).

The example steering load monitoring circuitry 304 receives outputs corresponding to position data from one or more of (a) the pinion shaft position sensor 210, which detects an angular position of the pinion shaft 204, or (b) a motor shaft position sensor 312 that detects a rotational angle of the shaft 310 of the motor 224. As disclosed herein, the steering load monitoring circuitry 304 determines acceleration of the rack 208 by calculating a second derivative of the position data for the pinion shaft 204 and/or the motor shaft 310 with respect to time. Using the rack acceleration data, the steering load monitoring circuitry 304 determines force applied to the inner tie rod 214, 220. If the steering load monitoring circuitry 304 determines that the calculated force applied to the inner tie rod 214, 220 surpasses, for example, a threshold force, the steering load monitoring circuitry 304 predicts that the inner tie rod 214, 220 experienced an excessive force event that likely affected the structural integrity of the inner tie rod 214, 220.

In examples in which the steering load monitoring circuitry 304 predicts, based on the force analysis, that the structural integrity of the inner tie rod 214, 220 is less than prior to the excessive force event, the steering load monitoring circuitry 304 verifies the prediction by analyzing alignment of the steering wheel 108. For example, the steering load monitoring circuitry 304 accesses driving behavior data from the ABS control circuitry 306 generated after the excessive force event to the inner tie rod 214, 220 (e.g., driving behavior data generated after the outputs corresponding to the pinion shaft position data and/or the motor shaft position data that was used to determine the rack acceleration and load and identify the excessive force event involving the inner tie rod 214, 220). The driving behavior data indicates whether the ABS control circuitry 306 has determined that the vehicle 100 is driving straight (e.g., based on acceleration data). The steering load monitoring circuitry 304 also analyzes changes in position data from the pinion shaft position sensor 210 and/or the motor shaft position sensor 312 that was generated after the excessive force event associated with the inner tie rod(s) 214, 220. If, for example, the position data from the pinion shaft position sensor 210 has changed by more than a threshold amount (e.g., 3 degrees) since the excessive force event, the steering load monitoring circuitry 304 determines that the steering wheel 108 may be misaligned due to effects of the excessive force event on the structural integrity of the inner tie rod 214, 220.

The example steering load monitoring circuitry 304 analyzes the driving behavior data from the ABS control circuitry 306 in view of the position data from one or more of the pinion shaft position sensor 210 or position data the motor shaft position sensor 312. If the driving behavior data from the ABS control circuitry 306 indicates that the car is driving straight but one or more of the position data from the pinion shaft position sensor 210 or the motor shaft position sensor 312 has changed by more than a threshold amount, then the steering load monitoring circuitry 304 determines that the steering wheel 108 is misaligned likely due to at least one of the inner tie rods 214, 220 having relatively less structural integrity than prior to the excessive force event. In such examples, the steering load monitoring circuitry 304 causes message(s) to be output to inform a user of possible structural integrity condition(s) involving the inner tie rod(s) 214, 220 or, more generally, the steering system 102. For example, the message(s) can include visual message(s) presented via user interface(s) of the vehicle 100 (e.g., user interface(s) on the dashboard 110).

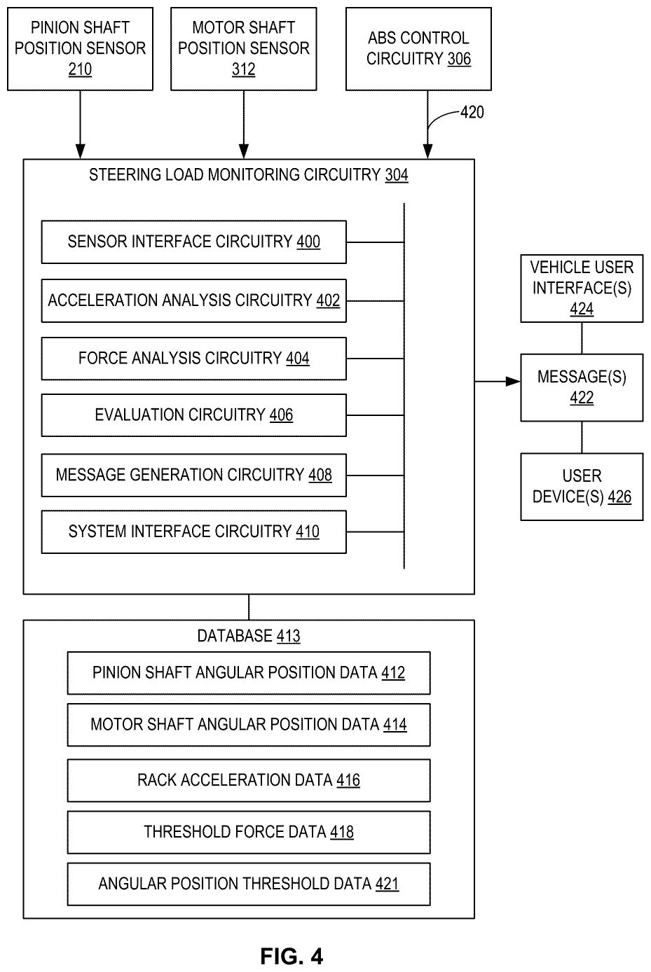

FIG. 4 is a block diagram of an example implementation of the steering load monitoring circuitry 304 of FIG. 3 to evaluate force(s) experienced by the component(s) (e.g., the inner tie rod(s) 214, 220) of the steering system 102 of the vehicle 100 of FIG. 1 and to provide message(s) to a user regarding the structural integrity of the steering system 102 based on the evaluation. The steering load monitoring circuitry 304 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the steering load monitoring circuitry 304 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

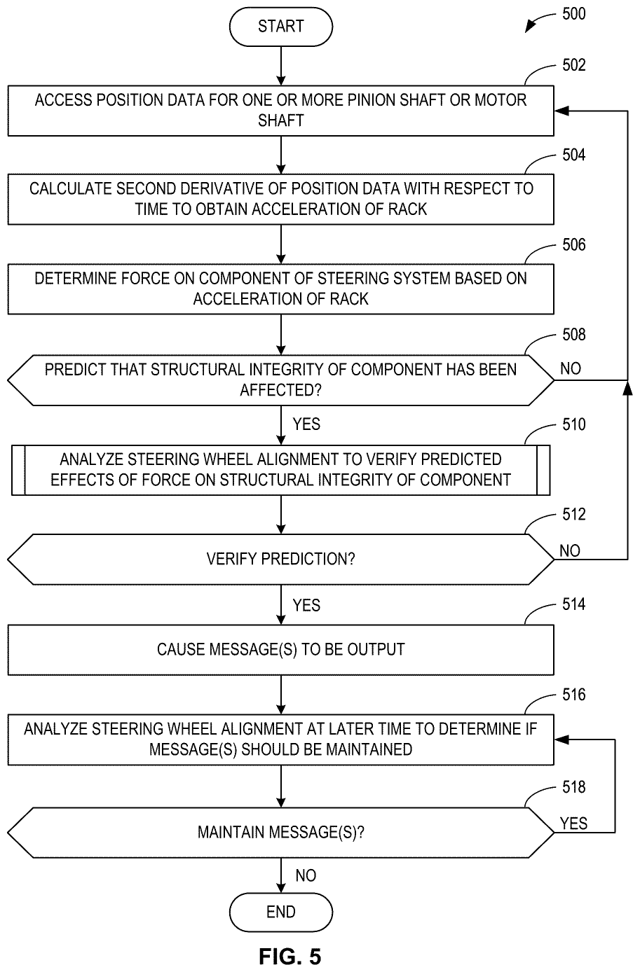

The example steering load monitoring circuitry 304 of FIG. 4 includes sensor interface circuitry 400, acceleration analysis circuitry 402, force analysis circuitry 404, evaluation circuitry 406, message generation circuitry 408, and system interface circuitry 410. In some examples, the sensor interface circuitry 400 is instantiated by programmable circuitry executing sensor interface instructions and/or configured to perform operations such as those represented by the flowchart(s) of FIGS. 5 and/or 6. In some examples, the acceleration analysis circuitry 402 is instantiated by programmable circuitry executing acceleration analysis instructions and/or configured to perform operations such as those represented by the flowchart(s) of FIGS. 5 and/or 6. In some examples, the force analysis circuitry 404 is instantiated by programmable circuitry executing force analysis instructions and/or configured to perform operations such as those represented by the flowchart(s) of FIGS. 5 and/or 6. In some examples, the evaluation circuitry 406 is instantiated by programmable circuitry executing evaluation instructions and/or configured to perform operations such as those represented by the flowchart(s) of FIGS. 5 and/or 6. In some examples, the message generation circuitry 408 is instantiated by programmable circuitry executing message generation instructions and/or configured to perform operations such as those represented by the flowchart(s) of FIGS. 5 and/or 6. In some examples, the system interface circuitry 410 is instantiated by programmable circuitry executing system interface instructions and/or configured to perform operations such as those represented by the flowchart(s) of FIGS. 5 and/or 6.

The example sensor interface circuitry 400 of FIG. 4 accesses outputs from the pinion shaft position sensor 210 indicative of angular positions of the pinion shaft 204 of the example steering system 102 of FIG. 2 over time. Additionally or alternatively, the sensor interface circuitry 400 accesses outputs from the motor shaft position sensor 312 indicative of angular positions of the shaft 310 of the motor 224 of the example steering system 102 over time. In the example of FIG. 4, pinion shaft angular position data 412 corresponding to the outputs of the pinion shaft position sensor 210 can be stored in a database 413. Additionally or alternatively, motor shaft angular position data 414 corresponding to the outputs of the motor shaft position sensor 312 can be stored in the database 413. In some examples, the database 413 is located external to the steering load monitoring circuitry 304 in a location accessible to the steering load monitoring circuitry 304, as shown in FIG. 4. In some examples, the steering load monitoring circuitry 304 of FIG. 4 includes the database 413.

The acceleration analysis circuitry 402 of FIG. 4 uses one or more of the pinion shaft angular position data 412 or the motor shaft angular position data 414 to determine translational acceleration of the rack 208 of the steering system 102. In examples disclosed herein, rack acceleration is indicative of how quickly a linear position of the rack 208 changes, which may be determined via changes in angular position of the pinion shaft 204 and/or the motor shaft 310. For example, when the wheel(s) 104, 106 experience loads, forces are transferred through the inner tie rod(s) 214, 220 to the rack 208. The rack 208, in response, translates quickly, which causes rotation of the ball nut 314 and the motor shaft 310. Changes in the rack acceleration data can indicate a sudden or rapid change in the linear position of the rack 208 due to high loads applied to the rack 208 as the vehicle 100 drives over, for instance, a pothole and the load(s) on the wheel(s) 104, 106 of the vehicle 100 are transferred to the rack 208. As a result, the inner tie rod(s) 214, 220 also likely experienced loads that affected the structural integrity of the inner tie rod(s) 214, 220.

In examples in which the sensor interface circuitry 400 receives outputs from both the pinion shaft position sensor 210 and the motor shaft position sensor 312, the acceleration analysis circuitry 402 can select one or more of the corresponding position data 412, 414 to determine rack acceleration. In some examples, the acceleration analysis circuitry 402 selects whichever one of the pinion shaft angular position data 412 or the motor shaft angular position data 414 indicates a greater amount of change in angular position of the pinion shaft 204 or the motor shaft 310, respectively, within a period of time (e.g., maximum value(s)) for use in determining rack acceleration. In some examples, the acceleration analysis circuitry 402 of FIG. 4 averages values from the pinion shaft angular position data 412 over time to generate average pinion shaft angular position data that is used to determine rack acceleration. In some examples, the acceleration analysis circuitry 402 averages values from the motor shaft angular position data 414 over time to generate average motor shaft angular position data that is used to determine rack acceleration.

The acceleration analysis circuitry 402 of FIG. 4 calculates a second derivative of the position data (e.g., the pinion shaft angular position data 412, the motor shaft angular position data 414) with respect to time. For example, the acceleration analysis circuitry 402 of FIG. 4 calculates the first derivative of the pinion shaft angular position data 412 and/or the motor shaft angular position data 414 with respect to time to generate velocity data. The acceleration analysis circuitry 402 calculates the derivative of velocity data with respect to time to obtain rack acceleration data 416. In the example of FIG. 4, the rack acceleration data 416 determined from the angular position data 412, 414 for the pinion shaft 204 and/or the motor shaft 310 represents acceleration of the rack 208. The rack acceleration data 416 can be stored in the database 413.

The force analysis circuitry 404 uses the rack acceleration data 416 to determine (e.g., predict) a force applied to the rack 208 and, by extension, at least one of the inner tie rods 214, 220. As disclosed below in connection with Equations 1-6, the force analysis circuitry 404 can determine the force applied to the rack 208, which can be used to predict excessive force applied to the inner tie rod 214, 220 as a function of rack acceleration. Equation 1 below sets forth that, neglecting friction, the mass of the rack 208 (m_{rack}) multiplied by acceleration of the rack 208 (a_{rack}) equals force applied to one of the inner tie rods 214, 220 (F_{Tie_Rod}) minus a reactive force (F_{BNA}) on the ball nut 314 (where the reactive force (F_{BNA}) causes a torque that is transferred to the motor 224 based on a belt-pulley ratio (Ratio_{Belt})), minus the force of the pinion 206 (F_{Pinion}):

m_{rack}*a_{rack}=F_{Tie_Rod}−F_{BNA}−F_{Pinion} (Equation 1).

Although Equation 1 above neglects friction, in other examples, friction can be accounted for in Equation 1.

Equation 2 below sets forth that torque applied to the ball nut 314 (T_{BNA}) equals the reactive force applied to the ball nut 314 (F_{BNA}) multiplied by a component of force (sin(θ)) perpendicular to the rack 208 axis and applied at a pitch radius of the rack 208 (D/2):

T_{BNA}=F_{BNA}*η*sin(θ)*D/2(Equation 2),

where η is an efficiency factor applied to account for real-world testing results.

Equation 3 below sets forth that the torque applied to the motor pulley 311 (T_{pulley}) is the torque applied to the ball nut (T_{BNA}) reduced by a mechanical advantage provided by the belt-pulley ratio (Ratio_{Belt}):

T_{pulley}=T_{BNA}/Ratio_{Belt} (Equation 3).

Equation 4 below sets forth that a torque applied to the motor 224 (Tₘₒₜₒᵣ) is equal to a torque of the motor pulley (T_{pulley}):

Tₘₒₜₒᵣ=T_{pulley} (Equation 4).

Equation 5 below sets forth that the torque applied to the motor 224 (Tₘₒₜₒᵣ) equals rotational acceleration of the motor 224 (aₘₒₜₒᵣ) multiplied by the motor's polar moment of inertia (Iₘₒₜₒᵣ):

Tₘₒₜₒᵣ=Iₘₒₜₒᵣ*αₘₒₜₒᵣ (Equation 5).

By substituting Equations 2-5 into Equation 1 and neglecting force applied to the pinion 206 (i.e., Fₚᵢₙᵢₒₙ=0), then the resulting Equation 6 relates translational rack acceleration (a_{rack}) to rotational motor acceleration (αₘₒₜₒᵣ):

m_{rack}*a_{rack}=F_{Tie_Rod}−(Iₘₒₜₒᵣ*αₘₒₜₒᵣ*Ratio_{Belt}/(η*sin(θ)*D/2)) (Equation 6).

In this example, Equation 6 can be solved for F_{Tie_Rod}, which represents the force applied to one of the inner tie rods 214, 220. Also, although Equation 6 does not account for force applied to the pinion 206 (i.e., F pinion), in other examples, Equation 6 can account for force on the pinion 206.

The evaluation circuitry 406 analyzes the force applied to the inner tie rod 214, 220 determined by the force analysis circuitry 404 to identify (e.g., predict) a likelihood that the structural integrity of the inner tie rod 214, 220 was affected. For example, the evaluation circuitry 406 compares the inner tie rod force F_{Tie_Rod} to a threshold force value defined by threshold force data 418 stored in the database 413. The threshold force value can be defined by, for example, user input(s) and selected based on, for example, previous testing of forces exerted on tie rods. In examples in which the inner tie rod force F_{Tie_Rod} exceeds the threshold force value, the evaluation circuitry 406 determines (e.g., predicts) that the inner tie rod 214, 220 experienced an excessive force event that likely affected the structural integrity of the inner tie rod 214, 220 and, thus, warrants generation of message(s) to inform the user.

In the example of FIG. 4, prior to instructing the message generation circuitry 408 to generate message(s) indicating that the inner tie rod 214, 220 likely has less structural integrity than prior to the excessive force event, the evaluation circuitry 406 verifies the likelihood that the predicted excessive force event caused the inner tie rod 214, 220 to have less structural integrity than prior to the predicted excessive force event. In examples disclosed herein, the evaluation circuitry 406 performs an analysis of alignment of an angle of the steering wheel 108 to verify the predicted effects of forces on the structural integrity of inner tie rod 214, 220. To perform the analysis of steering wheel angle alignment, the evaluation circuitry 406 requests, via the system interface circuitry 410, data 420 from the ABS control circuitry 306 regarding driving behavior of the vehicle 100, where the vehicle driving behavior data 420 is generated after occurrence of the excessive force event identified by the evaluation circuitry 406. In particular, the vehicle driving behavior data 420 obtained from the ABS control circuitry 306 indicates whether the ABS control circuitry 306 considers the vehicle 100 to be driving straight or substantially straight at given time. The evaluation circuitry 406 also retrieves (e.g., from the database 413) pinion shaft angular position data 412 and/or motor shaft angular position data 414 corresponding to outputs of the pinion shaft position sensor 210 or the motor shaft position sensor 312, where the sensor outputs are generated during a period of time after the predicted excessive force event. Put another way, the pinion shaft angular position data 412 and/or motor shaft angular position data 414 used in the steering wheel alignment analysis is generated at a later time than the pinion shaft angular position data 412 and/or motor shaft angular position data 414 used by the acceleration analysis circuitry 402 to determine rack acceleration. The pinion shaft angular position data 412 and/or motor shaft angular position data 414 retrieved for the steering wheel alignment analysis can correspond to outputs of the sensor(s) 210, 312 at the same time or substantially the same time as the vehicle driving behavior data 420 generated by the ABS control circuitry 306 (i.e., the position data 412, 414 for the steering wheel alignment analysis is time-correlated with the vehicle driving behavior data 420).

The evaluation circuitry 406 compares the angular position of the pinion shaft 204 and/or the angular position of the motor shaft 310 to an angular position threshold value defined by angular position threshold data 421 stored in the database 413. Based on the comparison, the evaluation circuitry 406 determines if the angular position of the pinion shaft 204 and/or the angular position of the motor shaft 310 has changed by more than the angular position threshold value since the occurrence of the excessive force event. Changes in angular position of the pinion shaft 204 and/or the motor shaft 310 that satisfy or exceed the angular position threshold value indicate a change in an angle of the steering wheel 108 associated with steering wheel misalignment.

For example, the evaluation circuitry 406 determines if the angular position of the pinion shaft 204 has changed by more than the angular position threshold value since the excessive force event associated with the inner tie rod 214, 220. In some examples, the angular position threshold value is 3 degrees. In such examples, if the angular position of the pinion shaft 204 has changed by 3 degrees or more, then the steering wheel angle has also changed by 3 degrees or more. Accordingly, in such examples, the evaluation circuitry 406 determines that the steering wheel 108 is misaligned. The angular position threshold value can have other values (e.g., 5 degrees, 2 degrees, etc.) defined by user input(s).

Additionally or alternatively, in some examples, the evaluation circuitry 406 analyzes the motor shaft angular position data 414 to determine if the steering wheel 108 is misaligned. Due to a motor reduction ratio or gear ratio of the motor 224, an angular position of the shaft 310 of the motor 224 changes more than angular position of the steering wheel 108. Accordingly, in such examples, prior to comparing the motor shaft angular position data 414 to the angular position threshold value to identify steering wheel misalignment, the evaluation circuitry 406 converts the angular position of the motor shaft 310 into a steering wheel angle value using known constants for a given steering system, including a C-factor for the steering system 102 (i.e., a distance the rack 208 travels per one complete revolution of the pinion 206), a pulley ratio for the motor 224, and a value associated with a screw lead of the steering system 102.

In other examples, the evaluation circuitry 406 determines that the steering wheel 108 is misaligned after the excessive force event when the change in angular position of one of the pinion shaft 204 and the motor shaft 310 after the excessive force event exceeds the angular position threshold value. In some examples, the evaluation circuitry 406 determines that the steering wheel 108 is misaligned when the change in angular positions of both the pinion shaft 204 and the motor shaft 310 after the excessive force event involving the inner tie rod 214, 220 exceed the angular position threshold value.

The evaluation circuitry 406 analyzes the vehicle driving behavior data 420 in view of the steering wheel alignment assessment performed using the position data 412, 414 for the pinion shaft 204 and/or the motor shaft 310. For example, the vehicle driving behavior data 420 can indicate that, at a given time, the vehicle 100 is driving straight. However, the corresponding position data 412, 414 for the pinion shaft 204 and/or the motor shaft 310 can indicate that the respective angular positions of the pinion shaft 204 and/or the motor shaft 310, and, thus, the steering wheel angle, changed by more than the angular position threshold value since the excessive force event (e.g., by more than 3 degrees). Thus, although the vehicle driving behavior data 420 indicates that the vehicle 100 is driving straight, the angular position(s) of pinion shaft 204 and/or the motor shaft 310 after the predicted excessive force event indicate that the steering wheel 108 is misaligned. In such examples, the evaluation circuitry 406 determines that the steering wheel 108 is likely misaligned due to effects of the excessive force event on the structural integrity of the inner tie rod 214, 220. As a result, the evaluation circuitry 406 verifies that the inner tie rod 214, 220 likely has less structural integrity than prior to the excessive force event, as predicted based on the force analysis (e.g., based on use of Equations 1-6, above, to determine the inner tie rod force F_{Tie_Rod} and comparison of the F_{Tie_Rod} to the threshold force value).

In examples in which the evaluation circuitry 406 verifies that structural integrity of the inner tie rod 214, 220 has been affected, the evaluation circuitry 406 instructs the message generation circuitry 408 to cause message(s) 422 to be output. The message(s) 422 can inform the user of structural integrity condition(s) involving the inner tie rod(s) 214, 220; inform the user of steering wheel misalignment; and/or, more generally, recommend that the user check the component(s) of the steering system 102 and/or suspension system of the vehicle 100. The message(s) 422 can include, for example, visual notification(s) to be displayed on a user interface(s) 424 of the vehicle 100 (e.g., of the dashboard 110). In such examples, the message generation circuitry 408 communicates with the system interface circuitry 410 to cause the message(s) 422 to be presented via the user interface(s) 424 of the vehicle 100. In some examples, the dashboard message(s) can be removed or reset via user input(s) at the vehicle 100. In some examples, the message generation circuitry 408 causes the message(s) 422 to be output to cloud-based device(s) (e.g., server(s), virtual machine(s)) to cause presentation of the message(s) 422 via an application installed on user device(s) 426 (e.g., a smartphone).

In some examples, based on the analysis of the vehicle driving behavior data 420 and the pinion shaft angular position data 412 and/or motor shaft angular position data 414, the evaluation circuitry 406 does not detect misalignment of the steering wheel 108. For example, the angular position of pinion shaft 204 and/or the motor shaft 310 after the occurrence of the excessive force event may have changed less than the angular position threshold value. In such examples, the evaluation circuitry 406 determines that although the force analysis identified a potential excessive force event sufficient to affect the structural integrity of the inner tie rod 214, 220, the event did not result in misalignment at the steering system 102. In such examples, the evaluation circuitry 406 may continue to monitor the vehicle driving behavior data 420, the pinion shaft angular position data 412, and/or motor shaft angular position data 414 to determine if steering wheel misalignment occurs over time and/or if another excessive force event is encountered. In such instances, the evaluation circuitry 406 may refrain from instructing the message generation circuitry 408 to generate the message(s) 422 until misalignment at the steering system 102 is detected.

While an example manner of implementing the steering load monitoring circuitry 304 of FIG. 3 is illustrated in FIG. 4, one or more of the elements, processes, and/or devices illustrated in FIG. 4 may be combined, divided, re-arranged, omitted, eliminated, and/or implemented in any other way. Further, the example sensor interface circuitry 400, the example acceleration analysis circuitry 402, the example force analysis circuitry 404, the example evaluation circuitry 406, the example message generation circuitry 408, the example system interface circuitry 410, and/or, more generally, the example steering load monitoring circuitry 304 of FIG. 4, may be implemented by hardware alone or by hardware in combination with software and/or firmware. Thus, for example, any of the example sensor interface circuitry 400, the example acceleration analysis circuitry 402, the example force analysis circuitry 404, the example evaluation circuitry 406, the example message generation circuitry 408, the example system interface circuitry 410, and/or, more generally, the example steering load monitoring circuitry 304, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example steering load monitoring circuitry 304 of FIG. 4 may include one or more elements, processes, and/or devices in addition to, or instead of, those illustrated in FIG. 4, and/or may include more than one of any or all of the illustrated elements, processes and devices.

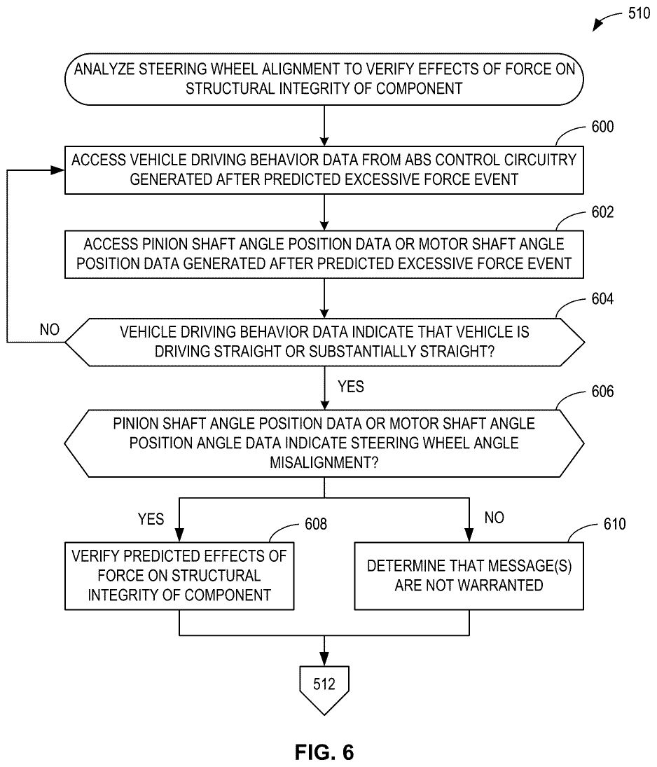

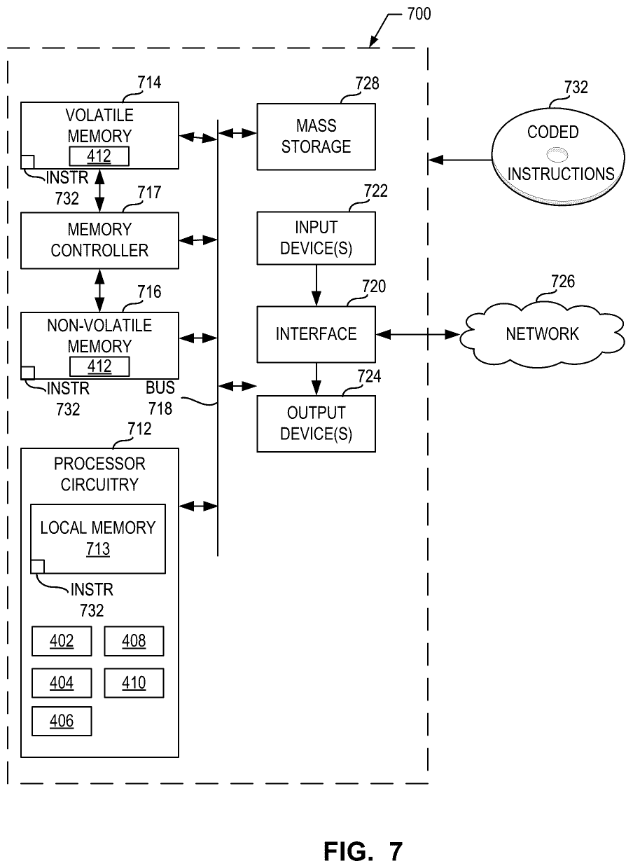

Flowchart(s) representative of example machine-readable instructions, which may be executed by programmable circuitry to implement and/or instantiate the steering load monitoring circuitry 304 of FIG. 4 and/or representative of example operations which may be performed by programmable circuitry to implement and/or instantiate the steering load monitoring circuitry 304 of FIG. 4, are shown in FIGS. 5 and 6. The machine-readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 5 and 6, many other methods of implementing the example steering load monitoring circuitry 304 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 5 is a flowchart representative of example machine-readable instructions and/or example operations 500 that may be executed, instantiated, and/or performed by programmable circuitry to evaluate load(s) experienced by a component of a steering system (e.g., the inner tie rod 214, 220 of the example steering system 102 of FIG. 2) of a vehicle (e.g., the example vehicle 100 of FIG. 1). The example machine-readable instructions and/or the example operations 500 of FIG. 5 begin at block 502, at which the sensor interface circuitry 400 of the example steering load monitoring circuitry 304 of FIG. 4 accesses pinion shaft angular position data 412 corresponding to outputs of the pinion shaft position sensor 210 in connection with rotation of the pinion shaft 204 and/or motor shaft angular position data 414 corresponding to outputs of the motor shaft position sensor 312 in connection with rotation of the motor shaft 310 of the motor 224.

At block 504, the acceleration analysis circuitry 402 of the steering load monitoring circuitry 304 of FIG. 4 calculates the acceleration (i.e., translational acceleration) of the rack 208 based on one or more of the pinion shaft angular position data 412 or the motor shaft angular position data 414. For example, the acceleration analysis circuitry 402 calculates the second derivative of the pinion shaft angular position data 412 and/or the motor shaft angular position data 414 to obtain rack acceleration data 416.

At block 506, the force analysis circuitry 404 uses the rack acceleration data 416 to determine (e.g., predict) a force applied to the component (e.g., the inner tie rod 214, 220) of the steering system 102. For example, the force analysis circuitry 404 executes Equations 1-6 disclosed above in connection with FIG. 4 to determine a force F_{Tie_Rod} on the inner tie rod 214, 220.

At block 508, the evaluation circuitry 406 compares the force (e.g., F_{Tie_Rod}) on the component (e.g., the inner tie rod 214, 220) to a threshold force value defined by the threshold force data 418. For example, if the evaluation circuitry 406 determines that the force applied to the inner tie rod 214, 220 satisfies or exceeds the threshold force value, then the evaluation circuitry 406 predicts that an excessive force event associated with forces sufficient or likely sufficient to affect (e.g., reduce) the structural integrity of the inner tie rod 214, 220 has occurred. If the force applied to the inner tie rod 214, 220 calculated by the force analysis circuitry 404 is less than the threshold force value, then the evaluation circuitry 406 does not predict that the inner tie rod 214, 220 has less structural integrity than before the excessive force event. In such examples, control returns to block 502 for continued monitoring of the angular position data 412, 414 for the pinion shaft 204 and/or the motor shaft 310 and rack acceleration.

If, at block 508, the evaluation circuitry 406 predicts an excessive force event that likely affected the structural integrity of the component (e.g., the inner tie rod 214, 220), then at block 510, the evaluation circuitry 406 verifies the prediction based on an analysis of alignment of the steering wheel 108, as further disclosed in connection with FIG. 6.

At block 512, if the evaluation circuitry 406 does not verify the predicted effects of forces on the structural integrity of the component (e.g., because the steering wheel alignment analysis does not indicate that the steering wheel 108 is misaligned), then control returns to block 502 for continued monitoring of rack acceleration.

If, at block 512, the evaluation circuitry 406 verifies the predicted effects on the structural integrity of the component (e.g., the inner tie rod 214, 220), then at block 514, the evaluation circuitry 406 instructs the message generation circuitry 408 to generate message(s) 422 to inform a user of the likelihood that the structural integrity of the component (e.g., the inner tie rod 214, 220) has been affected. The system interface circuitry 410 can cause the message(s) 422 to be displayed via, for example, a user interface 424 of the dashboard 110 of the vehicle 100.

At block 516, the evaluation circuitry 406 continues to analyze the alignment of the steering wheel 108 to determine if the message(s) 422 should be maintained. At block 518, the message generation circuitry 408 determines whether to maintain the message(s) 422 based on feedback from the evaluation circuitry 406 and/or user input(s) (e.g., an input to turn off or reset the message(s) 422). Control ends when the message(s) are no longer to be maintained.

FIG. 6 is a flowchart representative of example machine-readable instructions and/or example operations 510 that may be executed, instantiated, and/or performed by programmable circuitry to analyze alignment of the steering wheel 108 of the vehicle 100 of FIG. 1 to verify the structural integrity condition of the component (e.g., the inner tie rod 214, 220) of the steering system 102 of the vehicle 100 as determined at block 508 of FIG. 5.

At block 600, the sensor interface circuitry 400 of FIG. 4 accesses vehicle driving behavior data 420 from the ABS control circuitry 306, where the vehicle driving behavior data 420 is generated after the occurrence of the predicted excessive force event causing the component (e.g., the inner tie rod 214, 220) to have relatively less structural integrity than prior to the excessive force event.

At block 602, the sensor interface circuitry 400 accesses pinion shaft angular position data 412 and/or motor shaft angular position data 414 corresponding to outputs of the respective sensors 210, 312 after the occurrence of the predicted excessive force event (i.e., outputs of the respective sensors 210, 312 at a time after the sensor output(s) associated with the position data accessed at block 502 of FIG. 5).

At block 604, the evaluation circuitry 406 determines if the vehicle driving behavior data 420 indicates that the ABS control circuitry 306 considers the vehicle 100 to be driving straight.

At block 606, the evaluation circuitry 406 determines if the pinion shaft angular position data 412 and/or motor shaft angular position data 414 indicates a change in angular position of the pinion shaft 204 and/or the motor shaft 310 that satisfies or exceeds an angular position threshold value defined by the angular position threshold data 421. For example, a change in an angular position of the pinion shaft 204 after the occurrence of the excessive force event on the component (e.g., the inner tie rod 214, 220) that exceeds the angular position threshold value can indicate that the steering wheel angle for the steering wheel 108 also exceeds the angular position threshold value and, thus, the steering wheel 108 is misaligned.

If (a) the evaluation circuitry 406 determines at block 604 that the vehicle driving behavior data 420 indicates that the ABS control circuitry 306 considers the vehicle 100 to be driving straight and (b) the evaluation circuitry 406 determines at block 606 that the steering wheel 108 is misaligned, then at block 608, the evaluation circuitry 406 verifies the predicted effects on the structural integrity of the component (e.g., the inner tie rod 214, 220) that was determined based on the force analysis at block 508 of FIG. 5. In such examples, then block 512 of FIG. 5 equals “yes” and control proceeds to block 514 of FIG. 5 to cause the message(s) 422 to be output.

If (a) the evaluation circuitry 406 determines at block 604 that the vehicle driving behavior data 420 indicates that the ABS control circuitry 306 considers the vehicle 100 to be driving straight and (b) the evaluation circuitry 406 determines at block 606 that the steering wheel angle is not misaligned, then at block 610, the evaluation circuitry 406 determines that the force experienced by the component (e.g., the inner tie rod 214, 220) did not cause steering wheel misalignment. In such examples, the evaluation circuitry 406 determines that the message(s) 422 are not warranted. In such examples, then block 512 of FIG. 5 equals “no” and control proceeds to block 502 of FIG. 5 for continued monitoring of rack acceleration.

FIG. 7 is a block diagram of an example programmable circuitry platform 700 structured to execute and/or instantiate the example machine-readable instructions and/or the example operations of FIGS. 5 and 6 to implement the steering load monitoring circuitry 304 of FIG. 4. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example sensor interface circuitry 400, the example acceleration analysis circuitry 402, the example force analysis circuitry 404, the example evaluation circuitry 406, the example message generation circuitry 408, and the example system interface circuitry 410.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIGS. 5 and 6 may be stored in the mass storage device 728, in the volatile memory 714, in the non-volatile memory 716, and/or on at least one non-transitory computer-readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that provide for detection of forces on a steering system of a vehicle and assessment of a likelihood that the structural integrity of a component (e.g., an inner tie rod) of the steering system has been affected due to the forces. Examples disclosed herein use outputs of position sensor(s) associated with a pinion shaft and/or a motor shaft to determine acceleration of a rack of the steering system. In examples disclosed herein, rack acceleration is used to determine force applied to the inner tie rod. Based on the force applied to the inner tie rod and factors such as vehicle driving behavior and steering wheel alignment, examples disclosed herein generate message(s) to inform a user of likely changes in the structural integrity of the steering system.

Example systems, apparatus, and methods for steering load detection are disclosed. Further examples and combinations thereof include the following:

Example 1 includes an apparatus including memory; machine-readable instructions; and at least one programmable circuit to at least one of instantiate or execute the machine-readable instructions to determine an acceleration of a rack of a steering system of a vehicle based on one or more of position data for a pinion shaft coupled to a pinion of the steering system or position data for a shaft of a motor of the steering system; determine a force applied to a tie rod of the vehicle based on the acceleration of the rack; and cause a message to be output based on the force.

Example 2 includes any preceding clause(s) of Example 1, wherein one or more of the at least one programmable circuit is to determine that an angle of the pinion shaft exceeds a threshold; and cause the message to be output responsive to the determination that the angle of the pinion shaft exceeds the threshold.

Example 3 includes any preceding clause(s) of any one or more of Examples 1 or 2, wherein one or more of the at least one programmable circuit is to determine that an angle of a steering wheel of the vehicle is misaligned based on vehicle driving data and the angle of the pinion shaft exceeding the threshold, the vehicle driving data indicative of the vehicle driving straight; and cause the message to be output based on the determination that the angle of the steering wheel is misaligned.

Example 4 includes any preceding clause(s) of any one or more of Examples 1-3, wherein one or more of the at least one programmable circuit is to calculate average pinon shaft position data based on the position data for the pinion shaft; and determine the acceleration of the rack based on the average pinion shaft position data.

Example 5 includes any preceding clause(s) of any one or more of Examples 1-4, wherein one or more of the at least one programmable circuit is to cause the message to be presented via a user interface of the vehicle.

Example 6 includes any preceding clause(s) of any one or more of Examples 1-5, wherein one or more of the at least one programmable circuit is to cause the message to be presented via a user device, the user device different than the vehicle.

Example 7 includes any preceding clause(s) of any one or more of Examples 1-6, wherein one or more of the at least one programmable circuit is to perform a comparison of the force applied to the tie rod to a force threshold value; and cause the message to be output when the force applied to the tie rod satisfies the force threshold value.

Example 8 includes at least one non-transitory machine-readable medium including machine-readable instructions to cause at least one programmable circuit to at least generate, based on first angular position data, translational acceleration data for a rack of a steering system of a vehicle, the first angular position data corresponding to one or more of outputs of a first position sensor associated with a pinion shaft of the steering system at a first time or outputs of a second position sensor associated with a shaft of a motor of the steering system at the first time; predict, based on the translational acceleration data, an excessive force event associated with a force applied to a component of the steering system; determine, based on second angular position data, an angle of a steering wheel of the vehicle, the second angular position data corresponding to one or more of outputs of the first position sensor at a second time or outputs of the second position sensor at the second time, the second time after the first time; and cause a message to be output for presentation based on the prediction of the excessive force event and the angle of the steering wheel.

Example 9 includes any preceding clause(s) of Example 8, wherein the machine-readable instructions are to cause one or more of the at least one programmable circuit to determine the force applied to the component based on the translation acceleration data for the rack and rotational acceleration data for the motor.

Example 10 includes any preceding clause(s) of any one or more of Examples 8 or 9, wherein the machine-readable instructions are to cause one or more of the at least one programmable circuit to perform a comparison of the force applied to the component to a force threshold value; and predict the excessive force event based on the comparison.

Example 11 includes any preceding clause(s) of any one or more of Examples 8-10, wherein the machine-readable instructions are to cause one or more of the at least one programmable circuit to perform a comparison of the second angular position data to an angular position threshold; and when the second angular position data satisfies the angular position threshold, determine that the angle of the steering wheel is misaligned.

Example 12 includes any preceding clause(s) of any one or more of Examples 8-11, wherein the machine-readable instructions are to cause one or more of the at least one programmable circuit to determine that the steering wheel of the vehicle is misaligned based on (a) the second angular position data satisfying the threshold and (b) vehicle driving data, the vehicle driving data indicative of the vehicle driving straight at the second time.

Example 13 includes any preceding clause(s) of any one or more of Examples 8-12, wherein the machine-readable instructions are to cause one or more of the at least one programmable circuit to generate the translational acceleration data based on the first angular position data corresponding to the one of the outputs of the first position sensor or the outputs of the second position sensor at the first time indicative of a greater change in angular position of the pinion shaft or the shaft of the motor, respectively.

Example 14 includes any preceding clause(s) of any one or more of Examples 8-13, wherein the machine-readable instructions are to cause one or more of the at least one programmable circuit to cause the message to be displayed via an interface of a dashboard of the vehicle.

Example 15 includes a vehicle including a steering system including a rack, a tie rod coupled to the rack, a pinion, and a pinon shaft coupled to the pinion; a position sensor to generate outputs indicative of angular positions of the pinon shaft; machine-readable instructions; and at least one programmable circuit to execute the machine-readable instructions to determine, based on the outputs of the position sensor, an acceleration of the rack, the acceleration associated with linear motion of the rack; determine, based on the acceleration of the rack, a force applied to the tie rod; and cause a message to be displayed on an interface of a dashboard of the vehicle based on the force.

Example 16 includes any preceding clause(s) of Example 15, wherein one or more of the at least one programmable circuit is to determine that the force exceeds a threshold value; and response to the force exceeding the threshold value, cause the message to be displayed.

Example 17 includes any preceding clause(s) of any one or more of Examples 15 or 16, wherein the position sensor is a first position sensor, the steering system further includes a motor coupled the rack, and further including a second position sensor to generate outputs indicative of angular positions of a shaft of the motor, wherein one or more of the at least one programmable circuit is to identify the outputs of the first sensor as indicative of a greater angular position change of the pinion shaft than the outputs of the second sensor with respect to an angular position change of the shaft of the motor; and select to the outputs of the first position sensor to determine the acceleration of the rack,

Example 18 includes any preceding clause(s) of any one or more of Examples 15-17, wherein one or more of the at least one programmable circuit is to determine the force applied to the tie rod based on a rotational acceleration of the shaft of the motor.

Example 19 includes any preceding clause(s) of any one or more of Examples 15-18, further including a steering wheel, wherein the outputs of the position sensor are associated with a first period of time and one or more of the at least one programmable circuit is to identify, based on outputs of the position sensor associated with a second period of time, a change in an angular position of the pinion shaft, the second period of time after the first period of time; determine that the change in the angular position of the pinion shaft exceeds an angular position threshold value; and cause the message to be output based on the determination that the change in the angular position of the pinion shaft exceeds the angular position threshold value.

Example 20 includes any preceding clause(s) of any one or more of Examples 15-19, further an antilock braking system, wherein one or more of the at least one programmable circuit is to cause the message to be output based on vehicle driving data generated by the antilock braking system and the determination that the change in the angular position of the pinion shaft exceeds the angular position threshold value.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
memory;
machine-readable instructions; and
at least one programmable circuit to at least one of instantiate or execute the machine-readable instructions to:
determine an acceleration of a rack of a steering system of a vehicle based on one or more of position data for a pinion shaft coupled to a pinion of the steering system or position data for a shaft of a motor of the steering system;
determine a force applied to a tie rod of the vehicle based on the acceleration of the rack; and
cause a message to be output based on the force.

2. The apparatus of claim 1, wherein one or more of the at least one programmable circuit is to:
determine that an angle of the pinion shaft exceeds a threshold; and
cause the message to be output responsive to the determination that the angle of the pinion shaft exceeds the threshold.

3. The apparatus of claim 2, wherein one or more of the at least one programmable circuit is to:
determine that an angle of a steering wheel of the vehicle is misaligned based on vehicle driving data and the angle of the pinion shaft exceeding the threshold, the vehicle driving data indicative of the vehicle driving straight; and
cause the message to be output based on the determination that the angle of the steering wheel is misaligned.

4. The apparatus of claim 1, wherein one or more of the at least one programmable circuit is to:
calculate average pinon shaft position data based on the position data for the pinion shaft; and
determine the acceleration of the rack based on the average pinion shaft position data.

5. The apparatus of claim 1, wherein one or more of the at least one programmable circuit is to cause the message to be presented via a user interface of the vehicle.

6. The apparatus of claim 1, wherein one or more of the at least one programmable circuit is to cause the message to be presented via a user device, the user device different than the vehicle.

7. The apparatus of claim 1, wherein one or more of the at least one programmable circuit is to:
perform a comparison of the force applied to the tie rod to a force threshold value; and
cause the message to be output when the force applied to the tie rod satisfies the force threshold value.

8. At least one non-transitory machine-readable medium comprising machine-readable instructions to cause at least one programmable circuit to at least:
generate, based on first angular position data, translational acceleration data for a rack of a steering system of a vehicle, the first angular position data corresponding to one or more of outputs of a first position sensor associated with a pinion shaft of the steering system at a first time or outputs of a second position sensor associated with a shaft of a motor of the steering system at the first time;
predict, based on the translational acceleration data, an excessive force event associated with a force applied to a component of the steering system;
determine, based on second angular position data, an angle of a steering wheel of the vehicle, the second angular position data corresponding to one or more of outputs of the first position sensor at a second time or outputs of the second position sensor at the second time, the second time after the first time; and
cause a message to be output for presentation based on the prediction of the excessive force event and the angle of the steering wheel.

9. The at least one non-transitory machine-readable medium of claim 8, wherein the machine-readable instructions are to cause one or more of the at least one programmable circuit to determine the force applied to the component based on the translation acceleration data for the rack and rotational acceleration data for the motor.

10. The at least one non-transitory machine-readable medium of claim 9, wherein the machine-readable instructions are to cause one or more of the at least one programmable circuit to:
perform a comparison of the force applied to the component to a force threshold value; and
predict the excessive force event based on the comparison.

11. The at least one non-transitory machine-readable medium of claim 8, wherein the machine-readable instructions are to cause one or more of the at least one programmable circuit to:
perform a comparison of the second angular position data to an angular position threshold; and
when the second angular position data satisfies the angular position threshold, determine that the angle of the steering wheel is misaligned.

12. The at least one non-transitory machine-readable medium of claim 11, wherein the machine-readable instructions are to cause one or more of the at least one programmable circuit to determine that the steering wheel of the vehicle is misaligned based on (a) the second angular position data satisfying the threshold and (b) vehicle driving data, the vehicle driving data indicative of the vehicle driving straight at the second time.

13. The at least one non-transitory machine-readable medium of claim 8, wherein the machine-readable instructions are to cause one or more of the at least one programmable circuit to generate the translational acceleration data based on the first angular position data corresponding to the one of the outputs of the first position sensor or the outputs of the second position sensor at the first time indicative of a greater change in angular position of the pinion shaft or the shaft of the motor, respectively.

14. The at least one non-transitory machine-readable medium of claim 8, wherein the machine-readable instructions are to cause one or more of the at least one programmable circuit to cause the message to be displayed via an interface of a dashboard of the vehicle.

15. A vehicle comprising:
a steering system including a rack, a tie rod coupled to the rack, a pinion, and a pinon shaft coupled to the pinion;
a position sensor to generate outputs indicative of angular positions of the pinon shaft;
machine-readable instructions; and
at least one programmable circuit to execute the machine-readable instructions to:
determine, based on the outputs of the position sensor, an acceleration of the rack, the acceleration associated with linear motion of the rack;
determine, based on the acceleration of the rack, a force applied to the tie rod; and
cause a message to be displayed on an interface of a dashboard of the vehicle based on the force.

16. The vehicle of claim 15, wherein one or more of the at least one programmable circuit is to:
determine that the force exceeds a threshold value; and
response to the force exceeding the threshold value, cause the message to be displayed.

17. The vehicle of claim 15, wherein the position sensor is a first position sensor, the steering system further includes a motor coupled the rack, and further including a second position sensor to generate outputs indicative of angular positions of a shaft of the motor, wherein one or more of the at least one programmable circuit is to:
identify the outputs of the first sensor as indicative of a greater angular position change of the pinion shaft than the outputs of the second sensor with respect to an angular position change of the shaft of the motor; and
select to the outputs of the first position sensor to determine the acceleration of the rack.

18. The vehicle of claim 17, wherein one or more of the at least one programmable circuit is to determine the force applied to the tie rod based on a rotational acceleration of the shaft of the motor.

19. The vehicle of claim 15, further including a steering wheel, wherein the outputs of the position sensor are associated with a first period of time and one or more of the at least one programmable circuit is to:
identify, based on outputs of the position sensor associated with a second period of time, a change in an angular position of the pinion shaft, the second period of time after the first period of time;
determine that the change in the angular position of the pinion shaft exceeds an angular position threshold value; and
cause the message to be output based on the determination that the change in the angular position of the pinion shaft exceeds the angular position threshold value.

20. The vehicle of claim 19, further an antilock braking system, wherein one or more of the at least one programmable circuit is to cause the message to be output based on vehicle driving data generated by the antilock braking system and the determination that the change in the angular position of the pinion shaft exceeds the angular position threshold value.
